(19) United States
(12) Patent Application Publication
(10) Pub. No.: US 2007/0031186 A1
(43) Pub. Date: Feb. 8, 2007

(54) Self-clinching D base

(76) Inventor: George R. Winton III, Lawrenceville, GA (US)

Correspondence Address: George R. Winton, 242 Ashbourne Trail, Lawrenceville, GA, 30043, US

(21) Appl. No.: 11/198,993

(22) Filed: Aug. 8, 2005

(51) Int. Cl. B25G 3/00

(52) U.S. Cl. 403/231

(57) ABSTRACT

A metal clinch-type fastener in the form of a D shape cross section, serves as a base for several applications including a right angle bracket and a cable tie hook.

### BACKGROUND-FIELD OF INVENTION

The present invention relates self-clinching fasteners and more specifically to cost effective fasteners that can only be clocked into a thin sheet panel one way.

### BACKGROUND-DESCRIPTION OF PRIOR ART

Over the previous decades self-clinching fasteners have displayed a round cross section. A round cross section has permitted the self-clinching fastener itself to be clocked into a sheet panel in an infinite number of orientations.

Recently, several self-clinching fasteners have been developed to be clocked into a sheet panel in four or less possible orientations.

One approach that provides only one possible clocking intended to join two thin sheets at a right angle was disclosed by Winton in U.S. Pat. No. 5,452,978. Winton '978 describes a self-clinching fastener that has a square and/or rectangular base. Winton '978 teaches of a base with a round self-clinching feature coupled with an out-board feature(s) used to prevent the Winton '978 from rotating once self-clinched to a sheet panel.

The disadvantage of this approach is the manufacturing costs to produce Winton '978. The process to produce Winton '978 would involve metal injection molding. The costs associated with such an established process would prevent Winton '978 from gaining any significant market share.

Another approach providing four possible clockings intended to join two sheets at a right angle was disclosed by Winton 5,489,175. Winton '175 teaches of a square self-clinching base that makes use of two parallel features used to self-clinch to a mating sheet panel. As in Winton '978, Winton '175 teaches of a tapped hole used to receive a fastener intended to join two sheets at a right angle. Although not cited in the Winton '175 claims, the drawings of Winton '175 shows a square base.

The disadvantages of Winton '175 are the costs associated with manufacturing coupled by its perceived square base. Because the parallel self-clinching features are perpendicular to an axis of the tapped hole, the manufacturing process for Winton '175 lends itself to the higher costs associated with metal injection molding. Moreover, the square base allows Winton '175 to be installed into a square hole in 4 possible orientations (clockings); thus a minimum of two of the orientations being 90° out from the needed clocking.

Another approach showing two possible clockings intended to join two sheets at a right angle was disclosed by Ross in U.S. Pat. No. 5,810,501. Ross '501 teaches of a rectangular base that self-clinches to a surrounding sheet panel. Ross '501 describes a fastener where the hole intended to receive a threaded fastener is parallel to the two linear self-clinching features. By making the tapped hole parallel to the linear self-clinching features, Ross '501 can be made from an extrusion process, metal injection molding process, or a process known as power metal processing (press metal). The first and last two processes are less costly then the metal injection molding process.

One disadvantage of the Ross '501 invention involves the hardness of the finished part. When fabricating steel parts using the press metal process, the hardness of the finished part is much less then that of cold drawn steel itself. In general, parts manufactured/molded from power metal tend not to be as hard as parts crafted from a bar of cold drawn steel.

When installing self-clinching fasteners in general, it is well known that in order to self-clinch a fastener into a sheet panel, the surrounding sheet panel must be softer than the fastener itself. The process of press metal fabrication can not produce a part hard enough to penetrate some steel panels found in industrial applications today. Nevertheless, the press metal process allows parts to be produced at a reasonable cost and still be hard enough for a limited number of industrial applications.

Another disadvantage of the Ross '501 invention is that for ever configuration needed for market, a separate mold is needed to fabricate that specific size. For the most part, this is the case with an extruded part, metal injected molded part, and parts fabricated from the press metal process.

Another disadvantage of the Ross '501 invention is the needed design symmetry of the fastener for correct installation into a rectangular hole in a sheet panel. Therefore, the Ross '501 invention must be symmetrical in order for it not to be installed backwards into a rectangular hole.

Thus far the disadvantages of the above inventions involve:
unwanted installed orientations: a.k.a., multiple clockings;
limited fastener hardness;
manufacturing costs associated with producing molded parts; and
the design requirement for a symmetrical fastener.

As it turns out there is a self-clinching prior art that takes on all of the above disadvantages (less the symmetry objection) and is not used as a right angle bracket. Bentrim in U.S. Pat. No. D461,705S disclosed a self-clinching cable hook. Bentrim '705S shows a rectangular self-clinching base with a non symmetrical hook built onto the rectangular base. In order to use the Bentrim '705S hook effectively, it must be clocked into a sheet panel via the correct orientation. As can be seen from the marketing literature from Penn Fastening Systems (see PEM Bulletin), Bentrim '705S has an indentation mark on the far side surface to direct the clocking of the fastener during installation into a sheet panel.

The Disadvantage of Bentrim '705S lies in the rectangular base coupled with the non-symmetrical design; it can be installed two ways. However, only one way is most often desired by an end user. Another disadvantage of Bentrim '705S is the cost of the manufacturing process; cast power metal. Made from power metal as stated in the PEM bulletin, the limited hardness of the inventive fastener also limits the number of applications.

Clearly, a common thread of disadvantages exists between the two applications; that being the right-angle bracket and the cable hook.

### SUMMARY OF THE INVENTION

Accordingly, several objects and advantages of my invention are:

(a) to produce a common base that overcomes the disadvantages as stated above; the base when combined with specific added features will serve as an intended application such as a right-angle bracket and/or a cable hook;

(b) to reduce the costs of manufacturing by producing an application on a screw machine whereby various steels with a specific hardness greater than that produced with the press metal process can be formed; and

(c) to produce a non symmetrical fastener that can only be installed one way from any given side of a sheet panel.

Still further objects and advantages will become apparent from a consideration of the ensuing description and drawings.

### DESCRIPTION OF THE DRAWINGS

FIG. 1 shows an isometric view of the inventive base;

FIG. 2 shows a side view of the inventive base;

FIG. 3 shows the inventive base with the added features of a hole and a guide lead producing a first inventive application that functions as a right angle bracket;

FIG. 4 shows a side view of FIG. 3;

FIG. 5 shows a front view of FIG. 3;

FIG. 6 shows an isometric view of the first inventive application and a sheet panel with a D hole intended to receive the inventive base;

FIG. 7 shows the first inventive application installed in a sheet panel and a screw in process of securing a second sheet panel;

FIG. 8 shows the first inventive application in relation to two sheet panels each at a right angle to one another;

FIG. 9 shows a second inventive application making use of the inventive base shown in FIG. 1 whereby the second inventive application functions as a cable tie hook;

FIG. 10 shows a side view of FIG. 9; and

FIG. 11 shows a third inventive application used to support a plastic molded component (plastic part not shown) thus producing a hybrid application.

### DESCRIPTION OF THE PREFERRED EMBODIMENT

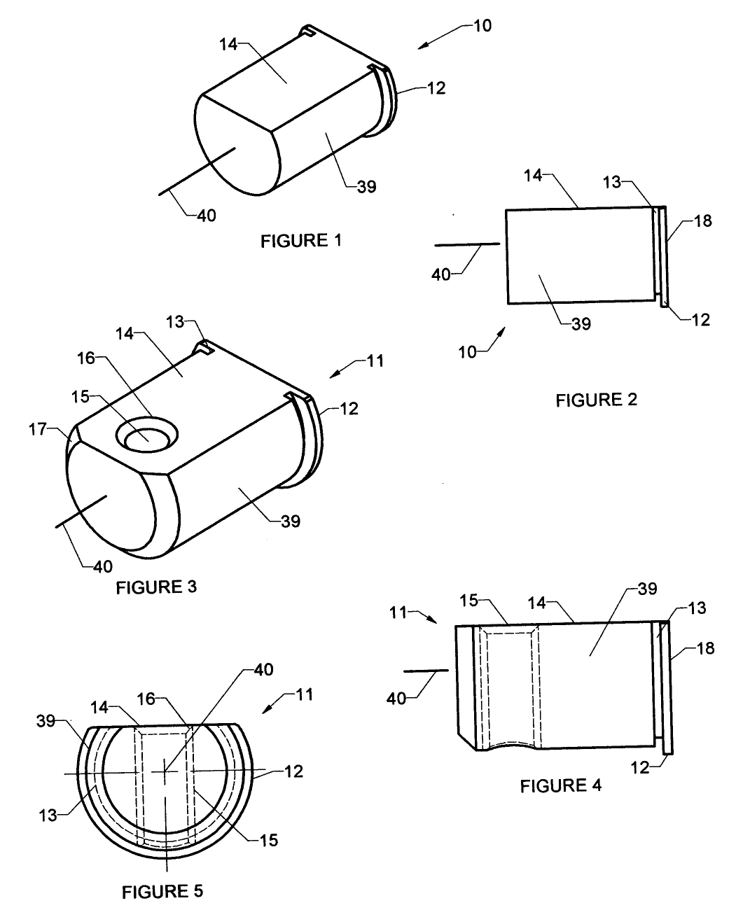

From FIGS. 1 and 2 the inventive metal base 10 is shown. Base 10 has a body 39. Body 39 has a D shaped cross section about an axis 40 that passes along the center of body 39. Formed adjacent to body 39 is an undercut groove 13. Undercut groove 13, as shown in FIGS. 1 and 2 also takes on a D shaped cross section about axis 40. Formed adjacent to undercut groove 13 is an extended land 12. Extended land 12 also takes on a D shaped cross section about axis 40. Body 39 has a top surface 14. Body 39, undercut groove 13, and extended land 12 all take on a round cross section less surface 14. By adding surface 14 to base 10, body 39, undercut groove 13, and extended land 12 all take on the D shaped cross section as described above. A face 18 forms the one side of extended land 12. Face 18 is perpendicular to surface 14.

A D shaped cross section of body 39 is seen when viewing base 10 along axis 40 in a direction towards extended land 12.

The diameter of body 39 is greater than the diameter of undercut groove 13 yet smaller than the diameter of extended land 12.

Undercut groove 13 is shown as a D shape cross section. However, if the diameter of undercut groove 13 were smaller then that depicted, undercut groove 13 might not display a D shape cross section and therefore would be completely circular in cross section. Nevertheless, the diameter of undercut groove 13 will always be smaller then the diameter of body 39.

From FIGS. 3, 4, and 5, a hole 15, a c′sink 16, and a guide lead 17 are added to base 10 to form first inventive application 11. Hole 15 is located on surface 14 and is perpendicular to surface 14. Hole 15 is circular in cross section and extends thru body 39. Hole 15 may or may not be threaded (female thread). C′sink 16 is formed on surface 14 and is concentric with hole 15. Guild lead 17 is formed on the end of body 39 opposite undercut groove 13 and is concentric about axis 40.

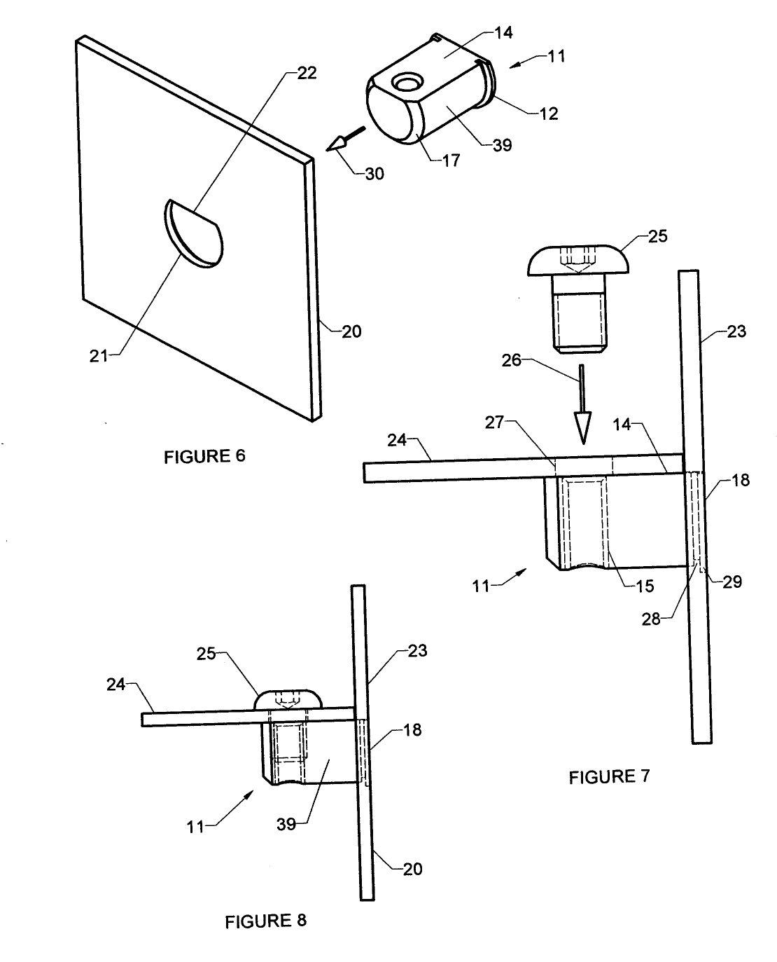

From FIG. 6, inventive application 11 is shown in relation to a sheet panel 20. Formed on sheet panel 20 is a D shaped hole 21. D shaped hole 21 shows a flat edge 22.

From FIG. 7, inventive application 11 is shown installed into sheet 20. Shown adjacent to surface 14 is a sheet panel 24. Formed thru sheet panel 24 is a hole 27. Shown above sheet panel 24 and above hole 15 is a threaded screw 25. Screw 25 may be of the self tapping type. Sheet 20 has a surface 23. Sheet 20 is shown to have cold flowed into an undercut groove 13. The material from hole 21 that is forced into undercut groove 13 is describe by the material 28.

From FIG. 8, screw 25 is installed into first inventive fastener 11 thus securing panel 24 to panel 20.

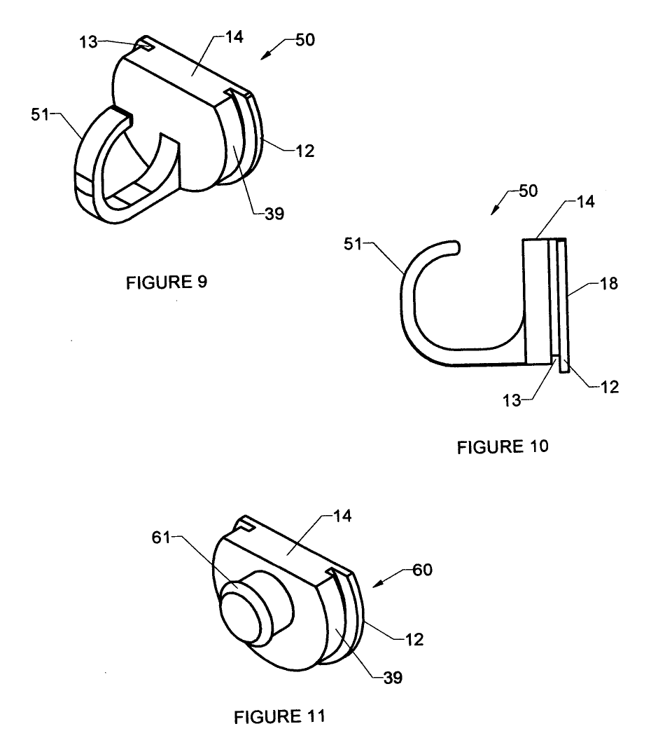

From FIGS. 9 and 10, a second inventive application 50 is shown. Inventive application 50 is derived from base 10 by removing various aspects of body 39. Application 50 has a hook 51. Hook 51 can be formed on a screw machine starting with base 10. By using a combination milling/drilling operation, hook 51 can be formed using modern computer controlled machines.

From FIGS. 6 and 11, a third inventive application 60 is derived from inventive base 10. Formed from body 39 is a barb 61. Barb 61 is intended to receive a plastic molded component (not shown). Once a plastic molded component is attached to barb 61, the hybrid (plastic joined to metal) application can be self-clinched into hole 21 for further down stream usage.

In operation, from FIGS. 6, 7, and 8, a right-angle bracket application is shown. Inventive application 11 is first passed thru hole 21 in sheet 20. Guide lead 17 first aligns body 39 with hole 21. In order to pass body 39 thru hole 21, surface 14 must be clocked with edge 22. Once edge 22 is clocked with surface 14, extended land 12 will contact surface 23. As force is applied to inventive fastener 11 via extended land 12, material 28 from sheet panel 20 will be forced (cold flow) into undercut groove 13 thus self-clinching inventive application 11 to sheet panel 20. Therefore, material 28 is forced into undercut groove 13 when extended land 12 forces (displaces) material 28 to cold flow into groove 13.

Inventive bracket 11 will be installed completely when surface 23 is flush with surface 18.

The self-clinching process is describe in most of the prior art cited and is considered will known by those schooled in the art of self-clinching fasteners.

Once inventive bracket 11 is installed, mating panel 24 can be joined to mating surface 14. Screw 25 can then be used to secure panel 20 to inventive application 11 thru hole 27.

In operation, from FIGS. 6, 9, and 10, inventive hook 50 is installed to a sheet panel 20 in the same manor as bracket 11. Once inventive hook 50 is self-clinched to a sheet panel, hook 51 can function as a device to receive a cable tie as described in Bentrim '705S.

From the discussion above it is obvious that inventive base 10 can be used to support numerous applications. For example, base 10 could be used to support an application crafted from nylon as described in FIG. 11. Therefore, the hybrid application (a metal base joined with nylon) would serve as a new application utilizing base 10 as a platform.

1-5. (canceled)

6. A metal, self-clinching type insert, comprising:
a D shaped rigid metal body formed adjacent to an undercut groove, formed adjacent to said undercut groove is a D shaped extended land, the cross section of said body and said extended land are each defined by an arc of less than 360 degrees and a straight line connecting the ends of the arc.

7. The metal-type insert of claim 6, wherein the body further includes a hole to receive a threaded fastener.

8. The metal-type insert of claim 6, further comprising a hook affixed to the body.

9. The metal-type insert of claim 6, further comprising a barb affixed to the body.

10. A method of inserting a metal, self-clinching type insert into a sheet panel, wherein the insert comprises a D shaped rigid metal body formed adjacent to an undercut groove, formed adjacent to said undercut groove is a D shaped extended land, the cross section of said body and said extended land are each defined by an arc of less than 360 degrees and a straight line connecting the ends of the arc, and wherein the sheet panel has a D shaped opening with a straight line, the method comprising:
aligning the straight line of the insert with the straight line of the opening;
inserting the insert into the opening, with the straight line of the insert aligned with the straight line of the opening; and
forcing the extended land into a side of the sheet panel, to force portions of the sheet panel to cold flow into the undercut groove.

11. The method of claim 10, wherein the body includes a hole extending through the body and perpendicular to a surface of the body including the straight line of the body.

12. The method of claim 10, further comprising a hook affixed to the body.

13. The method of claim 10, further comprising a barb affixed to the body.
